(19) United States
(12) Patent Application Publication
(10) Pub. No.: US 2022/0210706 A1
(43) Pub. Date: Jun. 30, 2022

(54) METHOD AND APPARATUS FOR IDENTIFYING TARGET NEIGHBOR CELL FOR HANDOVER OF USER EQUIPMENT (UE)

(71) Applicant: Sterlite Technologies Limited, Gurgaon (IN)

(72) Inventors: Shyam Parekh, Orinda, CA (US); Kevin Tang, Dublin, CA (US); Ravishankar Ravindran, San Ramon, CA (US)

(21) Appl. No.: 17/139,487

(22) Filed: Dec. 31, 2020

(51) Int. Cl. H04W 36/00; H04W 36/30

(52) U.S. Cl. CPC H04W 36/0085; H04W 36/30; H04W 36/0061

(57) ABSTRACT

The present invention discloses a method and apparatus for identifying a target neighbor cell for handover of a user equipment (UE) positioned in a serving cell to the target neighbor cell, a cell covering a location for serving the UE, the serving cell is adjacent to the plurality of neighbor cells, in a wireless communication network. The method comprising obtaining a received signal strength value and a load value for each candidate cells, wherein said signal strength value comprises one of Reference Signals Received Power (RSRP) and Reference Signal Received Quality (RSRQ) and wherein said load values comprises physical resource block (PRB) utilization values. Further, the method includes performing sorting of candidate cells using a nested dual level threshold-based sorting process. Further, the method includes selecting a target cell from the sorted plurality of candidate cells.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

### Field of the Invention

The present disclosure relates to a wireless communication system, and more specifically relates to a method and apparatus for identifying a target neighbor cell for handover of a user equipment (UE).

### Description of the Related Art

As a location of a user equipment (UE) is moved from a service area defined by “X” cell into that defined by “Y” cell, the UE must disconnect with “X” base station and connect with “Y” base station (i.e., establish a new connection). This operation is sometimes known as handover (HO) or a cell reselection.

One important operation while performing the HO, for example, is that the UE requires to monitor signalling strength values of “Y” cells that is neighbour to the “X” cell to which the UE is connected thereto, (i.e., “serving cell”). More particularly, the HO operation involves comparing the monitored signalling strength values of the neighbour cells (the “Y” cells) with a signalling strength value of the serving cell (the “X” cell). In case, if the signalling strength value of the neighbour cell is considered by the UE to be stronger than that of the serving cell, the UE initiates the HO to the neighbour cell, which becomes the new serving cell.

A sole requisite of performing the HO based on relative signal strength values may not be sufficient for performing the inter-RAT (radio access technology) or intra-RAT HO. For example, it may be possible for a UE to be handed over to a cell where the higher cell load could result in a poor performance for the UE.

Hence, even when the target cell may provide improved signal strength values for the UE following the HO, performance at the target cell may not be ideal. Therefore, failing to achieve load balancing across different cells in 4G/LTE and 5G networks in a manner that results in optimal UE performance.

Accordingly, the present invention seeks to ameliorate one or more of the aforementioned disadvantages or provide a useful alternative.

### BRIEF SUMMARY OF THE INVENTION

The principal objective of the present invention is to provide an efficient handover (HO) mechanism of a user equipment (UE) to a neighbour cell that ensures optimum usage of resources within a radio access network.

Another objective of the present invention is to provide sorting mechanism to identify a target cell for handover.

Another objective of the present invention is to determine a best candidate target cell for handover by identifying correct combination for reference signal received power (RSRP) and average load values for the cell. Further protecting against HO of the UE towards a target cell resulting in lower performance.

Another objective of the present invention is to execute parallel execution of threads (parallelly for each A3 event indication) for identification of best target cells by sorting list of candidate cells according to RSRP/RSRQ (reference signal received quality) values and PRB utilization (physical resource block) values.

Another objective of the present invention is to rank the neighbour cells based on a nested dual level threshold-based sorting with a reduced computation power.

Another objective of the present invention is to ensure optimal performance for UEs while achieving efficient load balancing across different cells in 4G/LTE and 5G networks, even after the HO operation.

Accordingly, herein discloses a method for identifying a target neighbor cell for handover of a user equipment (UE) positioned in a serving cell to the target neighbor cell, a cell covering a location for serving the UE, the serving cell is adjacent to the plurality of neighbor cells, in a wireless communication network. The method comprising obtaining a received signal strength value and a load value for each candidate cells, wherein said signal strength value comprises one of Reference Signals Received Power (RSRP) and Reference Signal Received Quality (RSRQ) and wherein said load values comprises physical resource block (PRB) utilization values. Further, the method includes performing sorting of candidate cells using a nested dual level threshold-based sorting process. Further, the method includes selecting a target cell from the sorted plurality of candidate cells.

The nested dual level threshold-based sorting process further comprising comparing the RSRP/RSRQ values of the plurality of neighbor cells with at least three RSRP/RSRQ threshold values. The at least three RSRP/RSRQ threshold values comprise a first RSRP/RSRQ threshold, a second RSRP/RSRQ threshold and a third RSRP/RSRQ threshold. Further, the method includes comparing the PRB utilization values of the plurality of neighboring cells with at least the first of the two PRB threshold values.

The nested dual level threshold-based sorting process further comprises filtering the plurality of neighbor cells in three bands based on the at least three RSRP/RSRQ threshold values. The three bands comprise a first band, a second band and a third band and wherein the first band includes candidate cells with high RSRP/RSRQ values compared to RSRP/RSRQ values of the second band and the third band, the second band includes candidate cells with moderate RSRP/RSRQ values compared to the RSRP/RSRQ values of the first band and the third band, and the third band includes candidate cells with low RSRP/RSRQ values compared to the RSRP/RSRQ values of the first band and the second band. The at least three RSRP/RSRQ threshold values comprise a first RSRP/RSRQ threshold, a second RSRP/RSRQ threshold and a third RSRP/RSRQ threshold. The first RSRP/RSRQ threshold value is the smallest threshold value, and a cell must have its RSRP/RSRQ value above this threshold value to be considered as a candidate cell. The second RSRP/RSRQ threshold is the second largest threshold value, and it is used to define the second band and the third band. The third RSRP/RSRQ threshold is the largest threshold value, and it is used to define the first band and the second band. Further, the method includes arranging the three bands on three different levels, in descending order, of the RSRP/RSRQ threshold values.

The nested dual level threshold-based sorting process further comprises filtering the plurality of neighbor cells in three bands based on the at least three RSRP/RSRQ threshold values. The three bands comprises a first band, a second band and a third band and wherein the first band includes candidate cells with high RSRP/RSRQ values compared to RSRP/RSRQ values of the second band and the third band, the second band includes candidate cells with moderate RSRP/RSRQ values compared to the RSRP/RSRQ values of the first band and the third band, and the third band includes candidate cells with low RSRP/RSRQ values compared to the RSRP/RSRQ values of the first band and the second band. The at least three RSRP/RSRQ threshold values comprise a first RSRP/RSRQ threshold, a second RSRP/RSRQ threshold and a third RSRP/RSRQ threshold. Further, the method includes arranging the three bands on three different levels in descending order, of RSRP/RSRQ threshold values. The first RSRP/RSRQ threshold value is the smallest threshold value, and a cell must have its RSRP/RSRQ value above this threshold value to be considered as a candidate cell. The second RSRP/RSRQ threshold is the second largest threshold value, and it is used to define the second band and the third band. The third RSRP/RSRQ threshold is the largest threshold value, and it is used to define the first band and the second band. Furthermore, the method includes sorting the plurality of neighbor cells within each band, from said arranged three bands, in descending order of RSRP/RSRQ values, where the first neighbor cell in each of the three band has highest RSRP/RSRQ value compare to other RSRP/RSRQ values of other neighbor cells in each of the three band.

The nested dual level threshold-based sorting process further comprises filtering the plurality of neighbor cells in three bands based on the at least three RSRP/RSRQ threshold values. The three bands comprises a first band, a second band and a third band and wherein the first band includes candidate cells with high RSRP/RSRQ values compared to RSRP/RSRQ values of the second band and the third band, the second band includes candidate cells with moderate RSRP/RSRQ values compared to the RSRP/RSRQ values of the first band and the third band, and the third band includes candidate cells with low RSRP/RSRQ values compared to the RSRP/RSRQ values of the first band and the second band. The at least three RSRP/RSRQ threshold values comprise a first RSRP/RSRQ threshold, a second RSRP/RSRQ threshold and a third RSRP/RSRQ threshold. Further, the method includes arranging the three bands on three different levels in descending order, of RSRP/RSRQ threshold values. The first RSRP/RSRQ threshold value is the smallest threshold value, and a cell must have its RSRP/RSRQ value above this threshold value to be considered as a candidate cell. The second RSRP/RSRQ threshold is the second largest threshold value, and it is used to define the second band and the third band. The third RSRP/RSRQ threshold is the largest threshold value, and it is used to define the first band and the second band. Furthermore, the method includes sorting the plurality of neighbor cells within each band, from said arranged three bands, in descending order of RSRP/RSRQ values, where the first neighbor cell in each of the three band has highest RSRP/RSRQ value compare to other RSRP/RSRQ values of other neighbor cells in each of the three band. Further, the method includes filtering the sorted plurality of neighbour cells within the first band, from top, if the load value (PRB utilization) of the neighbour cell is less than at least one PRB threshold value and selecting the filtered neighbour cell as the target cell for handover.

The nested dual level threshold-based sorting process further comprises filtering the plurality of neighbor cells in three bands based on the at least three RSRP/RSRQ threshold values. The three bands comprises a first band, a second band and a third band and wherein the first band includes candidate cells with high RSRP/RSRQ values compared to RSRP/RSRQ values of the second band and the third band, the second band includes candidate cells with moderate RSRP/RSRQ values compared to the RSRP/RSRQ values of the first band and the third band, and the third band includes candidate cells with low RSRP/RSRQ values compared to the RSRP/RSRQ values of the first band and the second band. The at least three RSRP/RSRQ threshold values comprise a first RSRP/RSRQ threshold, a second RSRP/RSRQ threshold and a third RSRP/RSRQ threshold. Further, the method includes arranging the three bands on three different levels in descending order, of RSRP/RSRQ threshold values. The first RSRP/RSRQ threshold value is the smallest threshold value, and a cell must have its RSRP/RSRQ value above this threshold value to be considered as a candidate cell. The second RSRP/RSRQ threshold is the second largest threshold value, and it is used to define the second band and the third band. The third RSRP/RSRQ threshold is the largest threshold value, and it is used to define the first band and the second band. Furthermore, the method includes sorting the plurality of neighbor cells within each band, from said arranged three bands, in descending order of RSRP/RSRQ values, where the first neighbor cell in each of the three band has highest RSRP/RSRQ value compare to other RSRP/RSRQ values of other neighbor cells in each of the three band. Further, the method includes filtering the sorted plurality of neighbour cell within the first band, from top, if the load value (PRB utilization) of the neighbour cell is less than a first PRB threshold value. Furthermore, the method includes selecting the filtered neighbour cell as the target cell for handover, if the load value (PRB utilization) of the neighbour cell is less than the first PRB threshold value. The method further includes filtering the sorted plurality of neighbor cell within the first band, from the top, if the load value (PRB utilization) of the neighbour cell is higher than the first PRB threshold value and lower than a second threshold value. Further, the method includes selecting the filtered neighbour cell as the target cell for handover, if the load value (PRB utilization) of the neighbour cell is higher than the first PRB threshold value and lower than the second threshold value.

The nested dual level threshold-based sorting process further comprises filtering the plurality of neighbor cells in three bands based on the at least three RSRP/RSRQ threshold values. The three bands comprises a first band, a second band and a third band and wherein the first band includes candidate cells with high RSRP/RSRQ values compared to RSRP/RSRQ values of the second band and the third band, the second band includes candidate cells with moderate RSRP/RSRQ values compared to the RSRP/RSRQ values of the first band and the third band, and the third band includes candidate cells with low RSRP/RSRQ values compared to the RSRP/RSRQ values of the first band and the second band. The at least three RSRP/RSRQ threshold values comprise a first RSRP/RSRQ threshold, a second RSRP/RSRQ threshold and a third RSRP/RSRQ threshold. Further, the method includes arranging the three bands on three different levels in descending order, of RSRP/RSRQ threshold values. The first RSRP/RSRQ threshold value is the smallest threshold value, and a cell must have its RSRP/RSRQ value above this threshold value to be considered as a candidate cell. The second RSRP/RSRQ threshold is the second largest threshold value, and it is used to define the second band and the third band. The third RSRP/RSRQ threshold is the largest threshold value, and it is used to define the first band and the second band. Furthermore, the method includes sorting the plurality of neighbor cells within each band, from said arranged three bands, in descending order of RSRP/RSRQ values, where the first neighbor cell in each of the three band has highest RSRP/RSRQ value compare to other RSRP/RSRQ values of other neighbor cells in each of the three band. Further, the method includes filtering the sorted plurality of neighbour cell within the first band, from top, if the load value (PRB utilization) of the neighbour cell within the first band is less than at least one PRB threshold values. Further, the method includes selecting the filtered neighbour cell as the target cell for handover, if the load value (PRB utilization) of the neighbour cell within the first band is less than the at least one PRB threshold values. Further, the method includes filtering the sorted plurality of neighbor cell within the second band, from the top, if the load value (PRB utilization) of the neighbour cell within the first band is higher than or equal to the at least one PRB threshold values and if the load value (PRB utilization) of the neighbour cell within the second band is less than the at least one PRB threshold values. The method further includes selecting the filtered neighbour cell within the second band as the target cell for handover, if the load value (PRB utilization) of the neighbour cell within the first band is higher than or equal to the at least one PRB threshold values and if the load value (PRB utilization) of the neighbour cell within the second band is less than the at least one PRB threshold values. Further, the method includes filtering the sorted plurality of neighbor cell within the third band, from the top, if the load value (PRB utilization) of the neighbour cell within the first band and second band is higher than or equal to the at least one PRB threshold values and if the load value (PRB utilization) of the neighbour cell within the third band is less than the at least one PRB threshold values. Furthermore, the method includes selecting the filtered neighbour cell within the third band as the target cell for handover, if the load value (PRB utilization) of the neighbour cell within the first band and the second band is higher than or equal to the at least one PRB threshold values and if the load value (PRB utilization) of the neighbour cell within the third band is less than the at least one PRB threshold values.

Further, the method includes selecting the filtered neighbor cell from the top within the first band as the target cell for handover, if the load value (PRB utilization) of the neighbour cell within each of the three bands is higher than or equal to the at least one PRB threshold values. The selected neighbor cell from the top has the highest RSRP/RSRQ values in the sorted plurality of candidate cells.

Further, the first PRB threshold is set at a lower value than the second PRB threshold. The two PRB thresholds are set to be lower than a load limit parameter called Cell Load Limit (CLL).

Further, the filtering of the sorted plurality of neighbor cells within the second band is initiated if the filtering of sorted plurality of neighbor cells in the first band does not filter any target cell. Further, the method includes selecting the filtered neighbour cell, from top of the filtered neighbour cells within the second band, as the target cell for handover.

The filtering of the sorted plurality of neighbor cells within the third band is initiated if the filtering of sorted plurality of neighbor cells in the first and second band does not filter any target cell. Further, the method includes selecting the filtered neighbour cell, from top of the filtered neighbour cells within the third band, as the target cell for handover.

The load value includes at least one of: average load value, mean load value, absolute load value and a range of load values.

The method further includes creating a data table of the plurality of candidate cells, where the data table stores the received signal strength value (RSRP/RSRQ) and the load value (PRB utilization) for each candidate cell. As per 3GPP ETSI TS 136 214 V9.1.0 (2010-04) technical specification, the RSRP may be defined as “Reference signal received power (RSRP), is defined as the linear average over the power contributions (in [W]) of the resource elements that carry cell-specific reference signals within the considered measurement frequency bandwidth.” RSRP may be the power of the LTE Reference Signals spread over the full bandwidth and narrowband. In some example, the PRB utilization values may be the radio resources utilized by a cell. The radio resource utilized by the cell may tell how much load is present in the cell. The PRB utilization values may signify the load parameters within the cell.

The nested dual level threshold-based sorting process is implemented by comparing the RSRP/RSRQ values with at least three RSRP/RSRQ threshold values and by comparing the PRB utilization values with at least two PRB threshold values.

The method provides a low power computation technique for sorting of the candidate cells. The method is implemented by the RAN intelligent controller in an O-RAN environment.

Accordingly, herein discloses an apparatus for identifying a target neighbor cell for handover of a user equipment (UE) positioned in a serving cell to the target neighbor cell, a cell covering a location for serving the UE, the serving cell is adjacent to the plurality of neighbour cells in a wireless communication network. The apparatus includes a memory, a controller coupled to the memory and a handover (HO) management unit, coupled to the controller, and is configured to obtain a received signal strength value and a load value for each candidate cells, wherein said signal strength value comprises one of Reference Signals Received Power (RSRP) and Reference Signal Received Quality (RSRQ) and wherein said load value comprises physical resource block (PRB) utilization value. Further, the HO management unit is configured to perform sorting of candidate cells using a nested dual level threshold-based sorting process and select the target neighbor cell from the sorted list of plurality of candidate cells.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modification.

### DESCRIPTION OF THE DRAWINGS

In order to best describe the manner in which the above-described embodiments are implemented, as well as define other advantages and features of the disclosure, a more particular description is provided below and is illustrated in the appended drawings. Understanding that these drawings depict only exemplary embodiments of the invention and are not therefore to be considered to be limiting in scope, the examples will be described and explained with additional specificity and detail through the use of the accompanying drawings in which:

FIG. 1 illustrates a wireless communication system;

FIG. 2 illustrates various hardware elements in an apparatus;

FIGS. 3a-3b are flow charts illustrating a method for selecting a candidate cell using a nested dual level threshold-based sorting process. The operations are performed by the apparatus;

FIG. 4 illustrates an open-radio access network (O-RAN) architecture; and

FIG. 5 is a flow chart illustrating a method for identifying the candidate cell. The operations are performed by the apparatus.

It should be noted that the accompanying figures are intended to present illustrations of few exemplary embodiments of the present disclosure. These figures are not intended to limit the scope of the present disclosure. It should also be noted that accompanying figures are not necessarily drawn to scale.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Reference will now be made in detail to selected embodiments of the present disclosure in conjunction with accompanying figures. The embodiments described herein are not intended to limit the scope of the disclosure, and the present disclosure should not be construed as limited to the embodiments described. This disclosure may be embodied in different forms without departing from the scope and spirit of the disclosure. It should be understood that the accompanying figures are intended and provided to illustrate embodiments of the disclosure described below and are not necessarily drawn to scale. In the drawings, like numbers refer to like elements throughout, and thicknesses and dimensions of some components may be exaggerated for providing better clarity and ease of understanding.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

It should be noted that the terms “first”, “second”, and the like, herein do not denote any order, ranking, quantity, or importance, but rather are used to distinguish one element from another. Further, the terms “a” and “an” herein do not denote a limitation of quantity, but rather denote the presence of at least one of the referenced item.

Standard Networking Terms and Abbreviation:

RAN: A RAN may stand for radio access network. A radio access network (RAN) may be a part of a telecommunications system which may connect individual devices to other parts of a network through radio connections. A RAN may provide a connection of user equipment such as mobile phone or computer with the core network of the telecommunication systems. A RAN may be an essential part of access layer in the telecommunication systems which utilize base stations (such as e node B, g node B) for establishing radio connections.

Wireless communication system: A wireless communication system may consist of various network components connected via wireless networks. The wireless networks may comprise of any wireless connectivity technology such as radio links, millimeter wave, etc. In this document, the wireless communication system may include one or more controller connected with radio access networks, which are further connected with a plurality of user equipments.

New RAN: A Radio Access Network which can support either NR/E-UTRA or both and have capabilities to interface with Next Generation Core Network (NG-CN). NG-C/U is a Control/User Plane interface towards NG-CN.

gNB: New Radio (NR) Base stations which have capability to interface with 5G Core named as NG-CN over NG-C/U (NG2/NG3) interface as well as 4G Core known as Evolved Packet Core (EPC) over S1-C/U interface.

LTE eNB: An LTE eNB is evolved eNodeB that can support connectivity to EPC as well as NG-CN.

Non-standalone NR: It is a 5G Network deployment configuration, where a gNB needs an LTE eNodeB as an anchor for control plane connectivity to 4G EPC or LTE eNB as anchor for control plane connectivity to NG-CN.

Standalone NR: It is a 5G Network deployment configuration where gNB does not need any assistance for connectivity to core Network, it can connect by its own to NG-CN over NG2 and NG3 interfaces.

Non-standalone E-UTRA: It is a 5G Network deployment configuration where the LTE eNB requires a gNB as anchor for control plane connectivity to NG-CN.

Standalone E-UTRA: It is a typical 4G network deployment where a 4G LTE eNB connects to EPC.

Xn Interface: It is a logical interface which interconnects the New RAN nodes i.e. it interconnects gNB to gNB and LTE eNB to gNB and vice versa.

As per the O-RAN Alliance (O-RAN-WG1 OAM Architecture-v02.00), “the near real time RAN Intelligent Controller (near RT RIC) is a logical function that enables near-real-time control and optimization of O-RAN elements and resources via fine-grained data collection and actions over E2 interface. The Non-Real Time Radio Intelligent Controller (non RT RIC) is a logical function that enables non-real-time control and optimization of RAN elements and resources, AI/ML workflow including model training and updates, and policy based guidance of applications/features in near-RT RIC. It is a part of the Service Management & Orchestration Framework and communicates to the near-RT RIC using the AI interface. Non-RT control functionality (>1 s) and near-Real Time (near-RT) control functions (<1 s) are decoupled in the RIC. Non-RT functions include service and policy management, RAN analytics and model-training for some of the near-RT RIC functionality, and non-RT RIC optimization. O-CU is O-RAN Central Unit, which is a logical node hosting RRC, SDAP and PDCP protocols. O-CU-CP is O-RAN Central Unit-Control Plane, which is a logical node hosting the RRC and the control plane part of the PDCP protocol. The O-CU-UP is O-RAN Central Unit-User Plane, which is a logical node hosting the user plane part of the PDCP protocol and the SDAP protocol. The O-DU is O-RAN Distributed Unit, which is a logical node hosting RLC/MAC/High-PHY layers based on a lower layer functional split. The O-RU is O-RAN Radio Unit, which is a logical node hosting Low-PHY layer and RF processing based on a lower layer functional split. This is similar to 3GPP's “TRP” or “RRH” but more specific in including the Low-PHY layer (FFT/iFFT, PRACH extraction). The O1 interface is an interface between management entities in Service Management and Orchestration Framework and O-RAN managed elements, for operation and management, by which FCAPS management, Software management, File management shall be achieved. The xAPP is an independent software plug-in to the Near-RT RIC platform to provide functional extensibility to the RAN by third parties.” The near-RT RIC controller can be provided different functionalities by using programmable modules as xAPPs, from different operators and vendors.

The AI interface may be defined as an interface between non-RT RIC and Near-RT RIC to enable policy-driven guidance of Near-RT RIC applications/functions, and support AI/ML workflow. The data packets which are communicated over the AI interface may be called AI messages. The E2 interface may be defined as an interface connecting the Near-RT RIC and one or more O-CU-CPs, one or more O-CU-UPs, and one or more O-DUs. The data packets which are communicated over E2 interface may be called E2 messages.

In the following detailed description of embodiments of the invention, numerous specific details are set forth in order to provide a thorough understanding of the embodiment of invention. However, it will be obvious to a person skilled in the art that the embodiments of the invention may be practiced with or without these specific details. In other instances, well known methods, procedures and components have not been described in details so as not to unnecessarily obscure aspects of the embodiments of the invention.

Furthermore, it will be clear that the invention is not limited to these embodiments only. Numerous modifications, changes, variations, substitutions and equivalents will be apparent to those skilled in the art, without parting from the scope of the invention.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

The plurality of candidate cells or candidate cell(s) are equivalently/interchangeably used as the plurality of neighbour cells or neighbour cell(s).

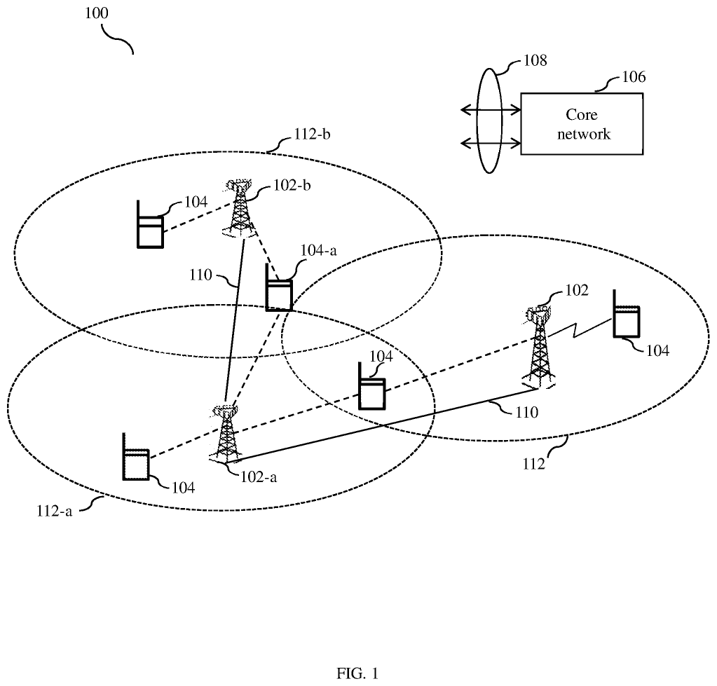

Referring now to the drawings, and more particularly to FIGS. 1 through 6, there are shown preferred embodiments.

FIG. 1 shows a block diagram of a wireless communication system (100).

The wireless communication system (100) includes a plurality of base stations (102, 102-a, 102-b), a number of user equipments (UEs) (104, 104-a), and a core network (106). The base stations (102, 102-a, 102-b) may communicate control information and/or user data with the core network (106) through backhaul (108). The wireless communication system (100) may support operation on multiple carriers. For example, each communication link (110) may be a multi-carrier signal modulated according to various radio technologies. Each modulated signal may be sent on a different carrier and may carry control information (e.g., reference signals, control channels, etc.), overhead information, data, etc.

The base stations (102, 102-a, 102-b) may wirelessly communicate with the UEs (104, 104-a) via one or more base station antennas. Each of the base stations (102, 102-a, 102-b) may provide communication coverage for a respective coverage area (112, 112-a, 112b). For example, the base station (102, 102-a, 102-b) may be referred to as a Radio Base Station (RBS), evolved Node B (“eNB”), “eNodeB”, “NodeB”, “B node”, gNB, or Base Transceiver Station (BTS), depending on the technology and terminology used.

A coverage area (112) for a base station (102) may be divided into sectors making up only a portion of the coverage area (not shown). The wireless communication system (100) may include base stations (102, 102-a, 102-b) of different types (e.g., macro, micro, and/or pico base stations). The base stations (102, 102-a, 102-b) may also utilize different radio access technologies, such as cellular and/or WLAN radio access technologies. The base stations (102, 102-a, 102-b) may be associated with the same or different access network or operator deployments. The coverage areas of different base stations (102, 102-a, 102-b), including the coverage areas of the same or different types of base stations (102, 102-a, 102-b), utilizing the same or different radio access technologies, and/or belonging to the same or different access network, may overlap. In some examples, a radio access network (RAN) may implement single radio access technology (RAT) (4G/5G) or multiple RATs (4G and 5G).

In some examples, a UE (104-a) may communicate with a serving base station (102-a) as it moves to the edge of a serving cell (112-a). In such an embodiment, the signal strength of the serving base station (102-a) becomes weak/deteriorate with respect to its communication with the UE (104-a) and as detailed in the background section i.e., a handover event is triggered from the serving cell (112-a) (comprising the serving base station (102-a) to at least one neighbour cell (112 or 112-b or 112-c . . . 112-n) comprising a target base station (102, 102-b, or 102-c . . . 102-n). In some example, a neighbour cell (112-b) may be considered as a target cell (112-b) (comprising a target base station (102-b)) to which the handover of the UE (104-a) is initiated. The handover event may also be triggered upon a handover request, for example, when a quality of the communication between the UE (104-a) and the serving base station (102-a) falls below a pre-defined threshold, set by corresponding network operator. The weak communication may be, for example, due to variations in channel quality, signal strengths, or the like, which causes the UE (104-a) leaving the serving cell (112-a) that is served by the serving base station (102-a) and entering into a new cell i.e., the at least one neighbour cell (112-b).

In some examples, the UE (104-a) may transmit periodic or event-based measurement reports to the serving base station (102-a). Further, a handover process may be initiated based on the transmission of the measurement reports from the UE (104-a) to the serving base station (102-a). In response to receiving the measurement reports at the serving base station (102-a), the base station may decide whether to trigger a handover and if so, decide to which target base station the UE (104-a) should be handed over. In addition to the measurement reports, other criteria may also be considered by the serving base station (102-a) before a control message is sent to the target base station (102-b) to prepare for the handover.

As detailed above (background section), conventional methods of facilitating the handover have focused solely on initiating a handover process based on the downlink measurement reports including Reference Signal Received Power (RSRP) and/or Reference Signal Received Quality (RSRQ). However, in accordance with the present disclosure, the E2 nodes may make cell load values i.e., physical resource block (PRB) utilization, available to the RAN intelligent controller in an O-RAN environment to assist the network in facilitating a handover. The E2 node may be an O-RAN node which is part of RAN and may be connected to the near-RT-RIC via an E2 interface. The E2 node may include a centralized unit (CU), a distributed unit (DU) and a radio unit (RU). The E2 nodes may connect with a plurality of UEs at one end and the near-RT-RIC at other end. The serving BS (106) may be the base station which is currently serving the UE. In another example, the serving BS may be the E2 node currently serving the UE. In further examples, the serving base station (102-a) triggers, for each A3 event, an evaluation of possible handover to all the available candidate cells (112 or 112-b or 112-c . . . 112-n) in process of selecting the best target cell (for example, the target cell (112-b)) i.e., parallel execution of threads (i.e., method as proposed herein) for each UE, causing an A3 event. Such evaluation is performed using a sorting list of candidate cells constructed based on RSRP/RSRQ and PRB utilization values.

A technical effect of the method proposed herein is that a low power computation technique for sorting of the plurality of candidate cells (112 or 112-b or 112-c . . . 112-n) can be provided.

As detailed above, selecting the target cell solely based on the RSRP/RSRQ values may not be ideal to perform the handover. Unlike conventional mechanism, in order to select the best candidate cell/network node, the present invention aims at considering sorting of the plurality of candidate cells based on a cell utilization/cell load (as one of the important handover parameter) in combination with RSRP/RSRQ values. Thereby, achieving load balancing across different cells in the 4G/LTE and 5G networks. Further, unlike conventional mechanism, the present invention provides a trade-off between the RSRP/RSRQ values and load values to provide the best candidate cell for HO.

The core network (106) may communicate with the base stations (102, 102-a, 102-b) via the backhaul (108) (e.g., 51 application protocol, etc.). The base stations (102, 102-a, 102-b) may also communicate with one another, e.g., directly or indirectly via backhaul links (108) (e.g., X2/Xn application protocol, etc.) and/or via backhaul (108) (e.g., through the core network (106)). The wireless communication system (100) may support synchronous or asynchronous operation. For synchronous operation, the eNBs may have similar frame and/or gating timing, and transmissions from different eNBs may be approximately aligned in time. For asynchronous operation, the eNBs may have different frame and/or gating timing, and transmissions from different eNBs may not be aligned in time. The techniques described herein may be used for either synchronous or asynchronous operations. In another aspect, the operations may be implemented on a 5G network.

The UEs (104, 104-a) may be dispersed throughout the wireless communication system (100), and each UE (104, 104-a) may be stationary or mobile. The UEs (104, 104-a) may also be referred to, by those skilled in the art, as a mobile device, a mobile station, a subscriber station, a mobile unit, a subscriber unit, a wireless unit, a remote unit, a wireless device, a wireless communication device, a remote device, a mobile subscriber station, an access terminal, a mobile terminal, a wireless terminal, a remote terminal, a handset, a user agent, a mobile client, a client, or some other suitable terminology. The UEs (104, 104-a) may be a cellular phone, a personal digital assistant (PDA), a wireless modem, a wireless communication device, a handheld device, a tablet computer, a laptop computer, a cordless phone, a wearable item such as a watch or glasses, a wireless local loop (WLL) station, or the like. The UEs (104, 104-a) may be able to communicate with macro eNBs, pico eNBs, femto eNBs, relays, and the like. The UEs (104, 104-a) may also be able to communicate over different types of access networks, such as cellular or other WWAN access networks, or WLAN access networks. In some modes of communication with the UEs (104, 104-a), communication may be conducted over a plurality of communication links (110) or channels (i.e., component carriers), with each channel or component carrier being established between the UE and one of a number of cells (e.g., serving cells, which in some cases may be different base stations (102, 102-a, 102-b).

The communication links (110) shown in the wireless communication system (100) may include uplink channels (or component carriers) for carrying uplink (UL) communications (e.g., transmissions from the UE (104) to the base station (102) and/or downlink channels (or component carriers) for carrying downlink (DL) communications (e.g., transmissions from the base station (102) to the UE (104)). The UL communications or transmissions may also be called reverse link communications or transmissions, while the DL communications or transmissions may also be called forward link communications or transmissions.

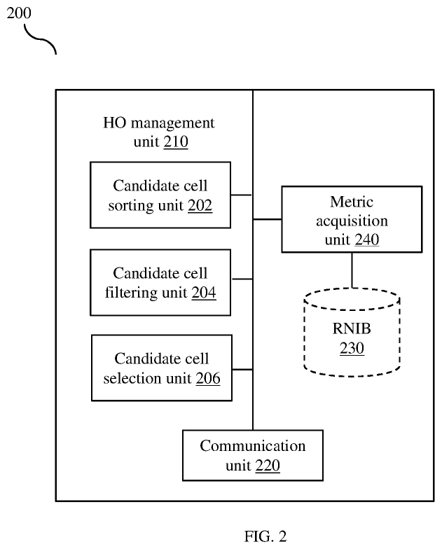

FIG. 2 shows a hardware component of an apparatus (200) for use in the wireless communication network (100), in accordance with various aspects of the present disclosure. In some examples, the apparatus (200) may be an example of aspects of one or more of the base stations (102, 102-a, 102-b) described with reference to FIG. 1. In some other example, the apparatus (200) may also be a radio access network (RAN) intelligent controller (RIC), or processor. The apparatus (200) comprises a handover management unit (210), a communication unit (220), a radio network information base (RNIB) (230) and a metric acquisition unit (240). In an example, the handover (HO) management unit (210) comprises a candidate cell sorting unit (202), a candidate cell filtering unit (204) and a candidate cell selection unit (206). Each of these hardware components may be in communication with each other. In some other example embodiments, the HO management unit (210) may also be implemented as the RIC, or processor, or any controller at the base stations (102, 102-a, 102-b) configured to perform the operations for identifying the best target cell.

The components of the apparatus (200) may be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

The metric acquisition unit (240) can be configured to receive various types of data and control plan information from the base station or the E2 nodes (in the O-RAN environment) of the wireless communication system (100). The metric acquisition unit (240) may receive information such as event indications, cell load information, signal strength at UEs, etc. The received information may be utilized by the HO management unit (210) to make a determination as to whether to either trigger the handover process for handing over a UE from the serving base station (102-a) to the target base station (102-b).

In some example, the HO management unit (210) may be configured to obtain a received signal strength value and a load value for each candidate cells (112 or 112-b or 112-c . . . 112-n). In some example, the signal strength value includes RSRP and/or RSRQ and the load values include the PRB utilization values. In some example embodiments, the load values include at least one of: average load value, mean load value, absolute load value and a range of load values. In one example, the RSRP and/or RSRQ and the PRB utilization may be obtained from the E2 nodes or the RNIB (230). The RNIB (230) may be a storage unit configured to store the obtained measurement reports including the RSRP and/or RSRQ and further to store the obtained PRB utilization values. In another example, the RNIB (230) may be located within the apparatus (200) and/or the base station (102) or may be remotely located to the apparatus (200) and/or the base station (102). The HO management unit (210) may be configured to transmit the obtained RSRP and/or RSRQ and the PRB utilization values to the candidate cell sorting unit (202).

In some examples, the candidate cell sorting unit (202) can be configured to perform the sorting of the candidate cells (112 or 112-b or 112-c . . . 112-n) using a nested dual level threshold-based sorting process. In some examples, the sorting is based on the obtained RSRP and/or RSRQ and the PRB utilization values. The nested dual level threshold-based sorting process includes comparing the RSRP/RSRQ values of the plurality of neighbor cells (112 or 112-b or 112-c . . . 112-n) with at least three RSRP/RSRQ threshold values. The at least three RSRP/RSRQ threshold values comprises a first RSRP/RSRQ threshold, a second RSRP/RSRQ threshold and a third RSRP/RSRQ threshold. Further, the candidate cell sorting unit (202) can be configured to compare the PRB utilization values of the plurality of neighboring cells (112 or 112-b or 112-c . . . 112-n) with at least one PRB threshold values, for example a first PRB threshold value and a second PRB threshold value. In some example, the comparison of the PRB utilization values of the plurality of neighboring cells (112 or 112-b or 112-c . . . 112-n) with the at least one PRB threshold values may also be executed by a comparator (not shown) communicatively coupled to the candidate cell sorting unit (202) and/or embedded within the candidate cell sorting unit (202). In some example, the at least one PRB threshold may include a first PRB threshold value and a second PRB threshold value.

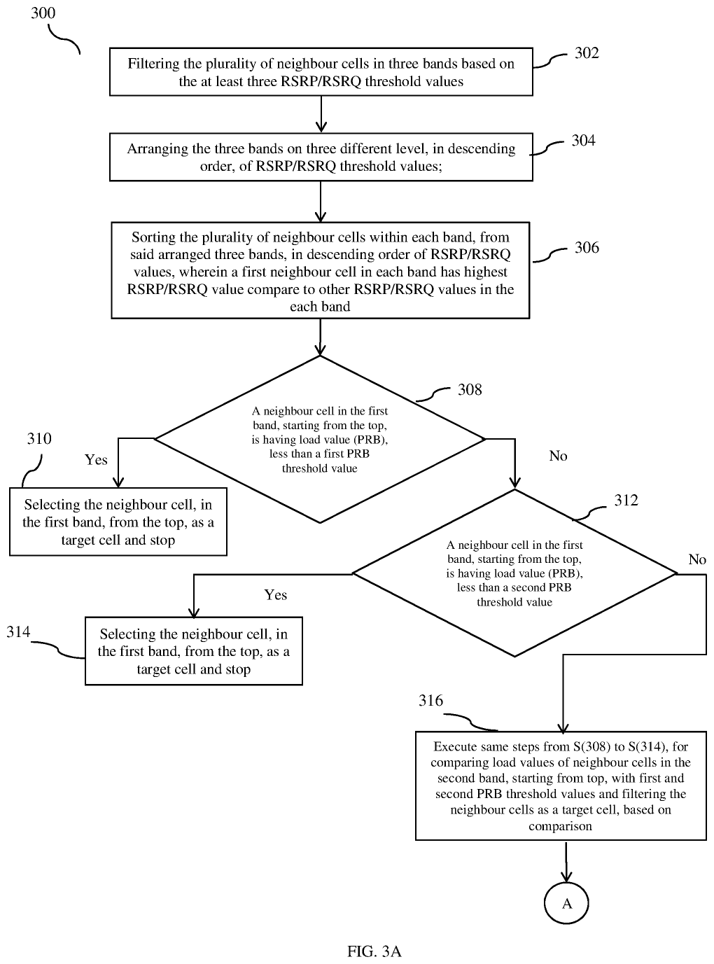

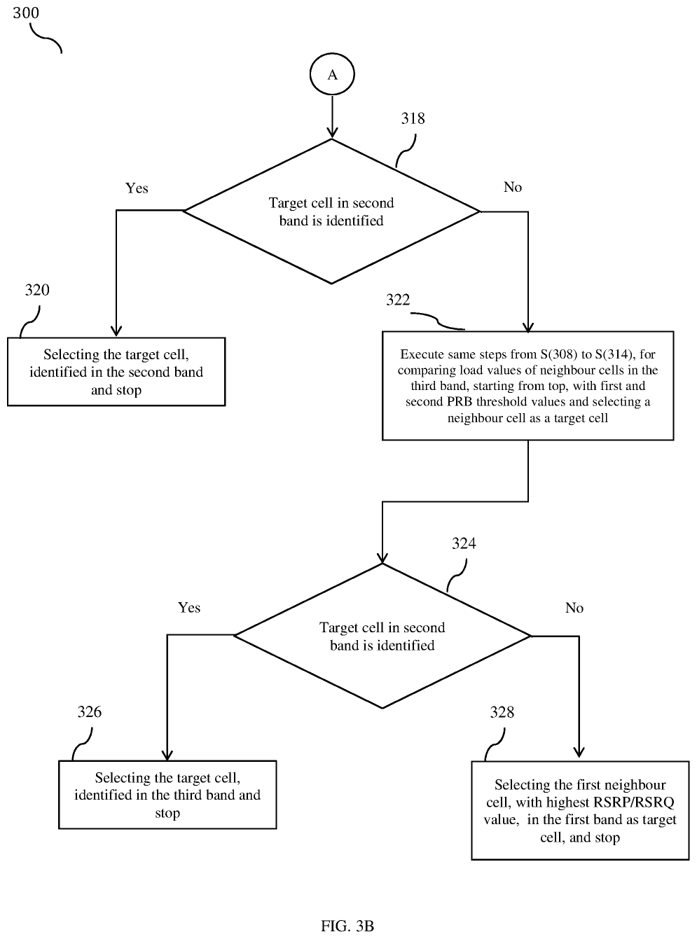

The step of performing the sorting of the candidate cells (112 or 112-b or 112-c . . . 112-n) using the nested dual level threshold-based sorting process is detailed below, in conjunction with FIGS. 3a and 3b.

At step (302), the candidate cell filtering unit (204), communicatively coupled to the candidate cell sorting unit (202), can be configured to filter the plurality of neighbor cells (112 or 112-b or 112-c . . . 112-n) in three bands based on the at least three RSRP/RSRQ threshold values. The three bands include a first band, a second band and a third band. In an example, the first band includes candidate cells (112 or 112-b or 112-c . . . 112-n) with high RSRP/RSRQ values compared to a RSRP/RSRQ values of the second band and the third band, the second band includes candidate cells (112 or 112-b or 112-c . . . 112-n) with moderate RSRP/RSRQ values compared to the RSRP/RSRQ values of the first band and the third band, and the third band includes candidate cells (112 or 112-b or 112-c . . . 112-n) with low RSRP/RSRQ values compared to the RSRP/RSRQ values of the first band and the second band. In further example, the at least three RSRP/RSRQ threshold values comprise a first RSRP/RSRQ threshold, a second RSRP/RSRQ threshold and a third RSRP/RSRQ threshold. Further, the HO management unit (210) can be configured to arrange, at step (304), the three bands on three different level, in descending order, of RSRP/RSRQ threshold values. The first RSRP/RSRQ threshold value is the smallest threshold value, and a cell must have its RSRP/RSRQ value above this threshold value to be considered as a candidate cell. The second RSRP/RSRQ threshold is the second largest threshold value, and it is used to define a second band and a third band. The third RSRP/RSRQ threshold is the largest threshold value, and it is used to define the first band and the second bands. The candidate cell sorting unit (202) can be configured to sort, at step (306), the plurality of neighbor cells (112 or 112-b or 112-c . . . 112-n) within each band, from said arranged three bands, in descending order of RSRP/RSRQ values, where a first neighbor cell in each band, from the top, has highest RSRP/RSRQ value compare to other RSRP/RSRQ values in each band.

For example, as illustrated below in Table.1 (i.e., data table) comprising the first band, the second band, and the third band arranged on three different levels using the RSRP/RSRQ threshold values. In some example, the arrangement of the three bands is in the descending order of the RSRP/RSRQ values. Further, the first band comprising the high RSRP/RSRQ values, higher than a third RSRP/RSRQ threshold, the third RSRP/RSRQ threshold having the highest RSRP/RSRQ threshold value) may be considered first for sorting using the nested dual level threshold-based sorting process. That is, within the first band, the neighbour cells are sorted in the descending order of their RSRP/RSRQ values. Similarly, within each of the second band and the third band, the neighbor cells are sorted in descending order of RSRP/RSRQ values. Further, filtering of the sorted plurality of neighbour cells within the first band is performed by using at least one PRB thresholds such as a first PRB threshold and a second PRB threshold. The first PRB threshold is set at a lower value than the second PRB threshold. The two PRB thresholds are also set to be lower than a load limit parameter called Cell Load Limit (CLL). At step (308), filtering of the sorted plurality of neighbour cell, starting from top, within the first band is performed to check if the PRB utilization of a neighbour cell in the first band is less than the first PRB threshold. If a neighbor cell is identified having the PRB utilization (load value) less than the first PRB threshold, in the first band, then selecting the neighbor cell as a target cell for handover, at the step (310). The target cell may be used by a user equipment (UE) for handover from a serving cell to the identified target neighbor cell. If no neighbor cell is identified, at step (312), filtering of the sorted plurality of neighbour cells within the first band, starting from the top, is performed to check if the PRB utilization value of a neighbour cell in the first band is less than the second PRB threshold. If a neighbor cell is identified having the PRB utilization (load value) less than the second PRB threshold, at step (314), in the first band, then selecting the neighbor cell as a target cell for handover. The filtered neighbour cell is identified as the target cell. At step (316), if no neighbour cell is found in the first band by the above dual filtering process, the dual filtering process is repeated for the neighbor cells in the second band. After step (316), the flow chart continues with the FIG. 3b, with step (318) followed by the previous step (316). If a neighbor cell is identified at step (320), then selecting the identified neighbor cell as the target cell for handover. Similarly, at step (322), if no neighbour cell is found in the first and second bands by the above dual filtering process, the dual filtering process is repeated for the third band. At step (324), filtering of the neighbor cell within the third band is performed based on the first PRB threshold and second PRB threshold sequentially, by the above dual filtering process. At step (326), if a neighbor cell is identified, selecting the neighbour cell as target cell for handover. Similarly, at step (328), if no neighbour cell is found in the first band, second band and the third band by the above dual filtering process, then selecting the first neighbor cell, from the top within the first band, having highest RSRP/RSRQ value, as the target cell for handover. Thus, the HO management unit (210) iteratively checks the three bands to identify desired target cell ID, based on three RSRP/RSRQ threshold and two PRB thresholds (the first PRB threshold and the second PRB threshold), thereby protecting against deciding on a target cell with a high PRB utilization.

TABLE 1

| | Neighbour | | PRB |
|---|---|---|---|
| | cell | RSRP/RSRQ | utilization |
| | ID | values | value |
| Excellent RSRP/ | Cell ID1 | RSRP/RSRQ1 | PRB utilization1 |
| RSRQ Band | Cell ID2 | RSRP/RSRQ2 | PRB utilization2 |
| Fair RSRP/RSRQ Band | Cell ID | RSRP/RSRQ | PRB utilization |
| Good RSRP/RSRQ Band | Cell ID | RSRP/RSRQ | PRB utilization |

Referring to the Table. 1, the plurality of neighbor cells (112 or 112-b or 112-c . . . 112-n) above the second RSRP/RSRQ threshold (highest RSRP/RSRQ threshold) are placed in the first band which corresponds to the Excellent RSRP/RSRQ band. Hence, the plurality of neighbor cells (112 or 112-b or 112-c . . . 112-n) in the first band are best contender for the target cell. Further, in view of the cells in the first band, the neighbor cells (112 or 112-b or 112-c . . . 112-n) in the second band (Fair band) and third band (Good band) may not be ideal for the consideration of the target cell on account of the RSRP/RSRQ values, as compared to the first band. On the other hand, the cells from the second band and the third band may be considered as the contenders for the selection of the target cell, only when the cells in the first band are not desirable due to load conditions, i.e., if the load value of neighbour cells in the first band are higher than the first PRB threshold value and the second PRB threshold value.

In another example, Table. 2 below discloses the band parameters (i.e., RSRP/RSRQ threshold parameters) and load parameters (i.e., load threshold parameters) with the corresponding signal strength and load values. For example, TH1=minimum RSRP/RSRQ threshold (i.e., a cell must have its RSRP/RSRQ value above this threshold value to be considered as a candidate cell), TH2=RSRP/RSRQ threshold for band 1 (i.e., neighbour cells with RSRP/RSRQ values above this threshold are in band 1) and TH3=RSRP/RSRQ threshold for band 2 (i.e., neighbour cells not belonging to band 1 and with RSRP/RSRQ values above this threshold are in band 2). The rest of the neighbour cells with RSRP/RSRQ above TH1 are in band 3. PRBTh1, and PRBTh2 are the PRB thresholds related to PRB utilizations. There is also a load limit parameter CLL (Cell Load Threshold) to bound the values of the PRB threshold values. How these thresholds are used in the nested dual level threshold-based sorting process is as described in [0066]. Further, the relative values of these parameters should satisfy TH0<TH1<TH2 and PRBTh1<PRBTh2<CLL.

TABLE 2

| Parameters | Example values |
|---|---|
| TH1, TH2, TH3 (RSRP) | −114 dBm, −103 dBm −85 dBm |
| Th1, TH2, TH3 (RSRQ) | −13 dB, −9 dB, −5 dB |
| PRBTh1, PRBTh2, CLL | 0.6, 0.7, 0.8 |

The HO management unit (210) can be further configured to determine, at step (308), if the load value (i.e., PRB utilization) of a neighbour cell (112 or 112-b or 112-c . . . 112-n), within the first band, is less than the first PRB threshold value (PRBTh1, as defined in Table. 2) and if none found, doing the same using the second PRB threshold value (PRBTh2, as defined in Table. 2). In response to determining that the load value (i.e., PRB utilization) of the neighbour cell (112 or 112-b or 112-c . . . 112-n), within the first band, is less than at least one of the PRB threshold values, the candidate cell filtering unit (204) can be configured to filter, at step (310) the plurality of neighbour cells within the first band, from top. The candidate cell selection unit (206) can be configured to select the filtered neighbour cell as the target cell (for e.g., the target cell (112-b) for the handover.

In response to determining that the load value (i.e., PRB utilization) of all the neighbour cells (112 or 112-b or 112-c . . . 112-n), within the first band, are greater than or equal to both the PRB threshold values (the first PRB threshold value and the second PRB threshold value), then the candidate cell filtering unit (204) can be configured to filter the sorted plurality of neighbour cells within the second band, from top, in a similar manner as in the first band. The candidate cell selection unit (206) can be configured to select the neighbour cell (112 or 112-b or 112-c . . . 112-n), from top of the filtered neighbour cells within the second band, as the target cell (for e.g., 112-b) for the handover. Similarly, selecting the neighbour cell (112 or 112-b or 112-c . . . 112-n), from top within the third band, as the target cell for handover, if all the neighbour cells (112 or 112-b or 112-c . . . 112-n) within the first and second bands fail to qualify after comparison with both the PRB threshold values. If all the three bands fail to qualify after comparison with both the PRB threshold values, then selecting the neighbor cell, from top, within the first band as the target cell for handover.

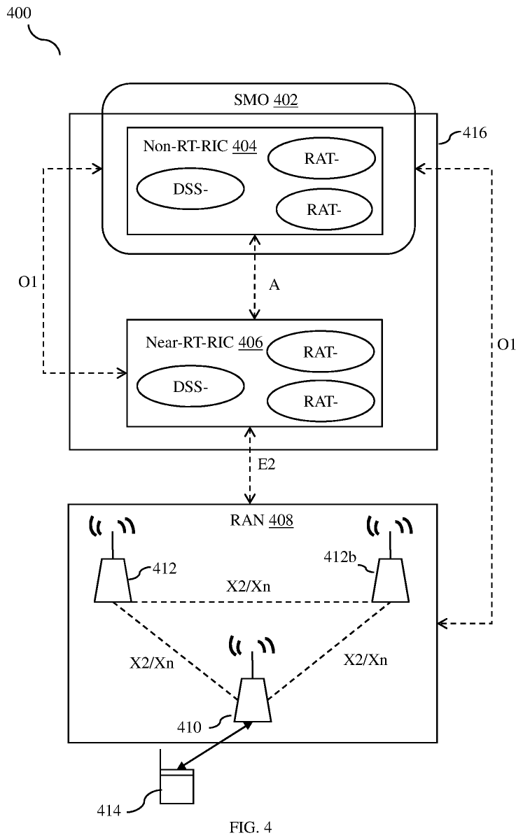

FIG. 4 illustrates an overview an Open-Radio Access Network (O-RAN) architecture (400) with a radio access network (RAN) intelligent controller (RIC) (416) and a Service Management and Orchestration (SMO) framework (402) connected to RAN (408). The O-RAN is an evolved version of prior radio access networks, makes the prior radio access networks more open and smarter than previous generations. The O-RAN provides real-time analytics that drive embedded machine learning systems and artificial intelligence back end modules to empower network intelligence. Further, the O-RAN includes virtualized network elements with open and standardized interfaces. The open interfaces are essential to enable smaller vendors and operators to quickly introduce their own services, or enables operators to customize the network to suit their own unique needs. Open interfaces also enable multivendor deployments, enabling a more competitive and vibrant supplier ecosystem. Similarly, open source software and hardware reference designs enable faster, more democratic and permission-less innovation. Further, the O-RAN introduces a self-driving network by utilizing new learning based technologies to automate operational network functions. These learning based technologies make the O-RAN intelligent. Embedded intelligence, applied at both component and network levels, enables dynamic local radio resource allocation and optimizes network wide efficiency. In combination with O-RAN's open interfaces, AI-optimized closed-loop automation is a new era for network operations.

The SMO (202) is configured to provide SMO functions/services such as data collection and provisioning services of the RAN (208). As per O-RAN Alliance (O-RAN-WG1 OAM Architecture-v02.00), the SMO can be defined as “Service Management and Orchestration Framework is responsible for the management and orchestration of the managed elements under its span of control. The framework can for example be a third-party Network Management System (NMS) or orchestration platform. Service Management and Orchestration Framework must provide an integration fabric and data services for the managed functions. The integration fabric enables interoperation and communication between managed functions within the O-RAN domain. Data services provide efficient data collection, storage and movement capabilities for the managed functions. In order to implement multiple OAM architecture options together with RAN service modeling, the modeling of different OAM deployment options and OAM services (integration fabric etc.) must be supported by SMO”. In the present disclosure, the RAN (408) is implemented by a base station (410) (or the base station (102, 102-a, 102-b)). For example, the apparatus (200) may be implemented as the RIC (416) in the O-RAN architecture (400). In some example, the RIC (416) may reside outside the RAN (208). In some example, the RIC (416) may control a plurality of RANs such as RAN (208). In some example, the RAN (208) may include the RIC (416). The SMO (402) is configured to provide SMO functions/services such as data collection and provisioning services of the RAN (408). The RAN (408), herein, is implemented in the O-RAN computing architecture (400). The RAN (408) may implement a single radio access technology (RAT) (4G/5G) or multiple RATs (4G and 5G) using the service/serving base station (410) and/or neighboring base stations (412-a and 412-b) (or the neighboring base stations (102-a, or 102-b, or 102-n)) located in the wireless communication network (100). The data collection of the SMO framework may include, for example, data related to a bandwidth of the wireless communication network (100) and the UE (104, 104-a).

The RIC (416) can be a non-real-time-radio intelligent controller (Non-RT-RIC) (404) and a near-real-time-radio intelligent controller (Near-RT-RIC) (406). The Non-RT-RIC (404) may be configured to support intelligent RAN optimization in non-real-time. Further, the Non-RT-RIC (404) can be configured to leverage the SMO services and may be a part of the SMO (402). One such advantage of configuring the RAN (408) within the O-RAN computing environment and/or O-RAN architecture (400) is leveraging the intellectualization (“Artificial intelligence (AD/Machine Learning (ML)) of the Non-RT-RIC (404) and the Near-RT-RIC (406).

The Near-RT-RIC (406) may host plurality of xApps, for example, a cell load monitoring xApp (x) that is configured to monitor the load of the cells and derive average load values using a suitable method, and candidate cell selection-xApp (y) that is configured to select a best candidate cell from a plurality of candidate cells based on indication of events (such as “A1-A6” events) and using subsequent RSRP/RSRQ reports. The xApps (at the Near-RT-RIC (406)) uses an “E2” interface to collect real-time measurements from the RAN (108) and to provide value added services using these primitives, guided by the policies/configuration and the enrichment data provided by the “AI” interface from the rApps at the Non-RT-RIC (504). An “01” interface collects data for training in the Non-RT RIC (404) (integrated with the SMO (402)).

In one example, the “E2” and “AI” interfaces may be used to collect real-time measurements, control messages, subscription messages, policy trigger messages, indication messages, machine learning (ML) management and enrichment information types of messages, and the like. The real-time measurements comprise RSRP/RSRQ measurements, channel quality measurements and the like. The subscription messages such as, for example, limited-time RSRP/RSRQ reports, limited-time A3 event indications, and the like. The policy trigger messages comprise, for example, spectrum allocation policies, radio assignment policies, and the like.

In an example, specific RAN functions can be provided over the E2 interface. The RAN functions may include, for example, are X2/Xn AP, F1AP, E1AP, S1AP, NGAP interfaces and the RAN (408) internal functions like the UEs (104, 104-a) and cell, node management.

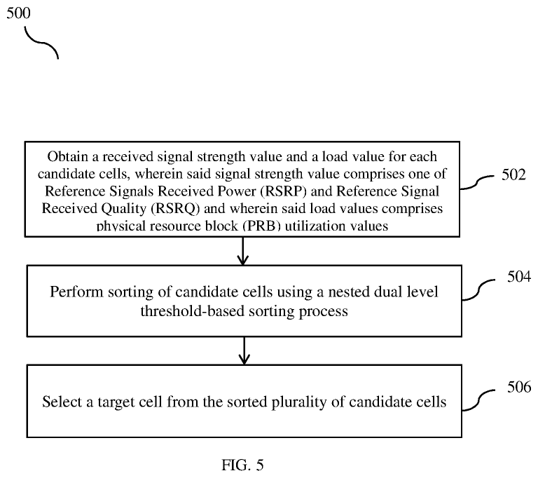

Referring to FIG. 5 that illustrates a flow chart (500) for identifying the target neighbor cell for handover of the UE (104, 104-a). The operations (502-506) are performed by the apparatus (200).

At step S502, the method includes obtaining the received signal strength values and the load value for each candidate cells, where said signal strength values comprise one of the RSRP and RSRQ, and wherein said load values comprises the PRB utilization values.

At step S504, the method includes performing sorting of candidate cells using a nested dual level threshold-based sorting process.

At step S506, the method includes selecting the target cell from the sorted plurality of candidate cells.

The various actions, acts, blocks, steps, or the like in the flow chart (300) and (500) may be performed in the order presented, in a different order or simultaneously. Further, in some embodiments, some of the actions, acts, blocks, steps, or the like may be omitted, added, modified, skipped, or the like without departing from the scope of the invention.

The embodiments disclosed herein can be implemented using at least one software program running on at least one hardware device and performing network management functions to control the elements.

In an aspect of the invention, the method may provide an efficient way of identifying a target cell for handover, which is not loaded in terms of PRB utilization. The method may provide a high RSRP/RSRQ neighbor cell as target cell, along with tradeoff of some RSRP/RSRQ values with PRB utilization value of the neighbor cells. The sorting method described in the invention may ensure considering only those neighbor cells for identifying as target cell which fulfills at least one RSRP/RSRQ thresholds and at least one PRB thresholds.

It will be apparent to those skilled in the art that other embodiments of the invention will be apparent to those skilled in the art from consideration of the specification and practice of the invention. While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope of the invention. It is intended that the specification and examples be considered as exemplary, with the true scope of the invention being indicated by the claims.

The methods and processes described herein may have fewer or additional steps or states and the steps or states may be performed in a different order. Not all steps or states need to be reached. The methods and processes described herein may be embodied in, and fully or partially automated via, software code modules executed by one or more general purpose computers. The code modules may be stored in any type of computer-readable medium or other computer storage device. Some or all of the methods may alternatively be embodied in whole or in part in specialized computer hardware.

The results of the disclosed methods may be stored in any type of computer data repository, such as relational databases and flat file systems that use volatile and/or non-volatile memory (e.g., magnetic disk storage, optical storage, EEPROM and/or solid-state RAM).

The various illustrative logical blocks, modules, routines, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

Conditional language used herein, such as, among others, “can,” “may,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

Although the present disclosure has been explained in relation to its preferred embodiment(s) as mentioned above, it is to be understood that many other possible modifications and variations can be made without departing from the spirit and scope of the inventive aspects of the present invention. It is, therefore, contemplated that the appended claim or claims will cover such modifications and variations that fall within the true scope of the invention.

What is claimed is:

1. A method for identifying a target neighbor cell for handover of a user equipment (UE) (104) positioned in a serving cell to the target neighbour cell, a cell covering a location for serving the UE, the serving cell is adjacent to the plurality of neighbour cells, in a wireless communication network (100), the method comprising:
obtaining a received signal strength value and a load value for each candidate cells, wherein said signal strength value comprises one of Reference Signals Received Power (RSRP) and Reference Signal Received Quality (RSRQ) and wherein said load values comprises physical resource block (PRB) utilization values;
performing sorting of candidate cells using a nested dual level threshold-based sorting process; and
selecting a target cell from the sorted plurality of candidate cells.

2. The method as claimed in claim 1, wherein the nested dual level threshold-based sorting process further comprising:
comparing the RSRP/RSRQ values of the plurality of neighbor cells with at least three RSRP/RSRQ threshold values; and
comparing the PRB utilization values of the plurality of neighboring cells with at least one PRB threshold values.

3. The method as claimed in claim 1, wherein the nested dual level threshold-based sorting process further comprising:
filtering the plurality of neighbor cells in three bands based on the at least three RSRP/RSRQ threshold values, wherein the three bands comprises a first band, a second band and a third band and wherein the first band includes candidate cells with RSRP/RSRQ values higher than RSRP/RSRQ values of candidate cells in the second band and the third band, the second band includes candidate cells with RSRP/RSRQ values lower than RSRP/RSRQ values of candidate cells in the first band and higher than RSRP/RSRQ values of candidate cells in the third band, the third band includes candidate cells with RSRP/RSRQ values lower than RSRP/RSRQ values of candidate cells in the first band and second band,
wherein the at least three RSRP/RSRQ threshold values comprises a first RSRP/RSRQ threshold, a second RSRP/RSRQ threshold and a third RSRP/RSRQ threshold, and
arranging the three bands on three different levels, in descending order, of RSRP/RSRQ threshold values.

4. The method as claimed in claim 1, wherein the nested dual level threshold-based sorting process comprising:
filtering the plurality of neighbor cells in three bands based on the at least three RSRP/RSRQ threshold values, wherein the three bands comprises a first band, a second band and a third band and wherein the first band includes candidate cells with RSRP/RSRQ values higher than RSRP/RSRQ values of candidate cells in the second band and the third band, the second band includes candidate cells with RSRP/RSRQ values lower than RSRP/RSRQ values of candidate cells in the first band and higher than RSRP/RSRQ values of candidate cells in the third band, the third band includes candidate cells with RSRP/RSRQ values lower than RSRP/RSRQ values of candidate cells in the first band and second band;
wherein the at least three RSRP/RSRQ threshold values comprises a first RSRP/RSRQ threshold, a second RSRP/RSRQ threshold and a third RSRP/RSRQ threshold;
arranging the three bands on three different levels, in descending order, of RSRP/RSRQ threshold values; and
sorting the plurality of neighbor cells within the three bands in descending order of RSRP/RSRQ values, wherein a first neighbor cell in each of the three band has highest RSRP/RSRQ value compare to other neighbor cells in each of the three bands.

5. The method as claimed in claim 1, wherein the nested dual level threshold-based sorting process comprising:
filtering the plurality of neighbor cells in three bands based on the at least three RSRP/RSRQ threshold values, wherein the three bands comprises a first band, a second band and a third band and wherein the first band includes candidate cells with RSRP/RSRQ values higher than RSRP/RSRQ values of candidate cells in the second band and the third band, the second band includes candidate cells with RSRP/RSRQ values lower than RSRP/RSRQ values of candidate cells in the first band and higher than RSRP/RSRQ values of candidate cells in the third band, the third band includes candidate cells with RSRP/RSRQ values lower than RSRP/RSRQ values of candidate cells in the first band and second band,
wherein the at least three RSRP/RSRQ threshold values comprises a first RSRP/RSRQ threshold, a second RSRP/RSRQ threshold and a third RSRP/RSRQ threshold;
arranging the three bands on three different levels, in descending order, of RSRP/RSRQ threshold values;
sorting the plurality of neighbor cells within the three bands in descending order of RSRP/RSRQ values, wherein a first neighbor cell in each of the three band has highest RSRP/RSRQ value compare to other neighbor cells in each of the three bands;
filtering the sorted plurality of neighbour cell within the first band, from top, if the load value (PRB utilization) of the neighbour cell is less than at least one PRB threshold value; and
selecting the filtered neighbour cell as the target cell for handover.

6. The method as claimed in claim 1, wherein the nested dual level threshold-based sorting process comprising:
filtering the plurality of neighbor cells in three bands based on the at least three RSRP/RSRQ threshold values, wherein the three bands comprises a first band, a second band and a third band and wherein the first band includes candidate cells with RSRP/RSRQ values higher than RSRP/RSRQ values of candidate cells in the second band and the third band, the second band includes candidate cells with RSRP/RSRQ values lower than RSRP/RSRQ values of candidate cells in the first band and higher than RSRP/RSRQ values of candidate cells in the third band, the third band includes candidate cells with RSRP/RSRQ values lower than RSRP/RSRQ values of candidate cells in the first band and second band,
wherein the at least three RSRP/RSRQ threshold values comprises a first RSRP/RSRQ threshold, a second RSRP/RSRQ threshold and a third RSRP/RSRQ threshold;
arranging the three bands on three different levels, in descending order, of RSRP/RSRQ threshold values;
sorting the plurality of neighbor cells within the three bands in descending order of RSRP/RSRQ values, wherein a first neighbor cell in each of the three band has highest RSRP/RSRQ value compare to other neighbor cells in each of the three bands;
filtering the sorted plurality of neighbour cell within the first band, from top, if the load value (PRB utilization) of the neighbour cell is less than a first PRB threshold value;
selecting the filtered neighbour cell as the target cell for handover, if the load value (PRB utilization) of the neighbour cell is less than the first PRB threshold value;
filtering the sorted plurality of neighbor cell within the first band, from the top, if the load value (PRB utilization) of the neighbour cell is higher than the first PRB threshold value and lower than a second threshold value; and
selecting the filtered neighbour cell as the target cell for handover, if the load value (PRB utilization) of the neighbour cell is higher than the first PRB threshold value and lower than the second threshold value;

7. The method as claimed in claim 1, wherein the nested dual level threshold-based sorting process comprising:
filtering the plurality of neighbor cells in three bands based on the at least three RSRP/RSRQ threshold values, wherein the three bands comprises a first band, a second band and a third band and wherein the first band includes candidate cells with RSRP/RSRQ values higher than RSRP/RSRQ values of candidate cells in the second band and the third band, the second band includes candidate cells with RSRP/RSRQ values lower than RSRP/RSRQ values of candidate cells in the first band and higher than RSRP/RSRQ values of candidate cells in the third band, the third band includes candidate cells with RSRP/RSRQ values lower than RSRP/RSRQ values of candidate cells in the first band and second band,
wherein the at least three RSRP/RSRQ threshold values comprises a first RSRP/RSRQ threshold, a second RSRP/RSRQ threshold and a third RSRP/RSRQ threshold;
arranging the three bands on three different levels, in descending order, of RSRP/RSRQ threshold values;
sorting the plurality of neighbor cells within the three bands in descending order of RSRP/RSRQ values, wherein a first neighbor cell in each of the three band has highest RSRP/RSRQ value compare to other neighbor cells in each of the three bands;
filtering the sorted plurality of neighbour cell within the first band, from top, if the load value (PRB utilization) of the neighbour cell within the first band is less than at least one PRB threshold values;
selecting the filtered neighbour cell as the target cell for handover, if the load value (PRB utilization) of the neighbour cell within the first band is less than the at least one PRB threshold values;
filtering the sorted plurality of neighbor cell within the second band, from the top, if the load value (PRB utilization) of the neighbour cell within the first band is higher than or equal to the at least one PRB threshold values and if the load value (PRB utilization) of the neighbour cell within the second band is less than the at least one PRB threshold values; and
selecting the filtered neighbour cell within the second band as the target cell for handover, if the load value (PRB utilization) of the neighbour cell within the first band is higher than or equal to the at least one PRB threshold values and if the load value (PRB utilization) of the neighbour cell within the second band is less than the at least one PRB threshold values;
filtering the sorted plurality of neighbor cell within the third band, from the top, if the load value (PRB utilization) of the neighbour cell within the first band and second band is higher than or equal to the at least one PRB threshold values and if the load value (PRB utilization) of the neighbour cell within the third band is less than the at least one PRB threshold values; and
selecting the filtered neighbour cell within the third band as the target cell for handover, if the load value (PRB utilization) of the neighbour cell within the first band and the second band is higher than or equal to the at least one PRB threshold values and if the load value (PRB utilization) of the neighbour cell within the third band is less than the at least one PRB threshold values.

8. The method as claimed in claim 1, wherein the nested dual level threshold-based sorting process comprising:
filtering the plurality of neighbor cells in three bands based on the at least three RSRP/RSRQ threshold values, wherein the three bands comprises a first band, a second band and a third band and wherein the first band includes candidate cells with RSRP/RSRQ values higher than RSRP/RSRQ values of candidate cells in the second band and the third band, the second band includes candidate cells with RSRP/RSRQ values lower than RSRP/RSRQ values of candidate cells in the first band and higher than RSRP/RSRQ values of candidate cells in the third band, the third band includes candidate cells with RSRP/RSRQ values lower than RSRP/RSRQ values of candidate cells in the first band and second band,
wherein the at least three RSRP/RSRQ threshold values comprises a first RSRP/RSRQ threshold, a second RSRP/RSRQ threshold and a third RSRP/RSRQ threshold;
arranging the three bands on three different levels, in descending order, of RSRP/RSRQ threshold values;
sorting the plurality of neighbor cells within the three bands in descending order of RSRP/RSRQ values, wherein a first neighbor cell in each of the three band has highest RSRP/RSRQ value compare to other neighbor cells in each of the three bands;
filtering the sorted plurality of neighbour cell within the first band, from top, if the load value (PRB utilization) of the neighbour cell within the first band is less than at least one PRB threshold values;
selecting the filtered neighbour cell as the target cell for handover, if the load value (PRB utilization) of the neighbour cell within the first band is less than the at least one PRB threshold values;
filtering the sorted plurality of neighbor cell within the second band, from the top, if the load value (PRB utilization) of the neighbour cell within the first band is higher than or equal to the at least one PRB threshold values and if the load value (PRB utilization) of the neighbour cell within the second band is less than the at least one PRB threshold values; and
selecting the filtered neighbour cell within the second band as the target cell for handover, if the load value (PRB utilization) of the neighbour cell within the first band is higher than or equal to the at least one PRB threshold values and if the load value (PRB utilization) of the neighbour cell within the second band is less than the at least one PRB threshold values;
filtering the sorted plurality of neighbor cell within the third band, from the top, if the load value (PRB utilization) of the neighbour cell within the first band and second band is higher than or equal to the at least one PRB threshold values and if the load value (PRB utilization) of the neighbour cell within the third band is less than the at least one PRB threshold values; and
selecting the filtered neighbour cell within the third band as the target cell for handover, if the load value (PRB utilization) of the neighbour cell within the first band and the second band is higher than or equal to the at least one PRB threshold values and if the load value (PRB utilization) of the neighbour cell within the third band is less than the at least one PRB threshold values,
selecting the filtered neighbor cell from the top within the first band as the target cell for handover, if the load value (PRB utilization) of the neighbour cell within each of the three bands is higher than or equal to the at least one PRB threshold values,
wherein the selected neighbor cell from the top has the highest RSRP/RSRQ values in the sorted plurality of candidate cells.

9. The method as claimed in claim 1, wherein the load value includes at least one of:
average load value, mean load value, absolute load value and a range of load values.

10. The method as claimed in claim 1, wherein the method further comprises:
creating a data table of the plurality of candidate cells,
wherein the data table stores the received signal strength value (RSRP/RSRQ) and the load value (PRB utilization) for each candidate cells.

11. The method as claimed in claim 1, wherein the nested dual level threshold-based sorting process is implemented by comparing the RSRP/RSRP values with at least three RSRP/RSRQ threshold values and by comparing the PRB utilization values with at least two PRB threshold values.

12. The method as claimed in claim 1, wherein the method provides a low power computation technique for sorting of the candidate cells.

13. The method as claimed in claim 1, wherein the method is implemented by a radio access network (RAN) intelligent controller in an Open-RAN environment.

14. An apparatus for identifying a target neighbor cell for handover of a user equipment (UE) positioned in a serving cell to the target neighbour cell, a cell covering a location for serving the UE, the serving cell is adjacent to the plurality of neighbour cells, in a wireless communication network, the apparatus comprising:
a handover management unit configured to:
obtain a received signal strength value and a load value for each candidate cells, wherein said signal strength value comprises one of Reference Signals Received Power (RSRP) and Reference Signal Received Quality (RSRQ) and wherein said load values comprises physical resource block (PRB) utilization values;
perform sorting of candidate cells using a nested dual level threshold-based sorting process; and
select the target neighbor cell from the sorted list of plurality of candidate cells.

15. The apparatus as claimed in claim 14, wherein the nested dual level threshold-based sorting process further comprising:
comparing the RSRP/RSRQ values of the plurality of neighbor cells with at least three RSRP/RSRQ threshold values; and
comparing the PRB utilization values of the plurality of neighboring cells with at least one PRB threshold values.

16. The apparatus as claimed in claim 14, wherein the nested dual level threshold-based sorting process further comprising:
filtering the plurality of neighbor cells in three bands based on the at least three RSRP/RSRQ threshold values, wherein the three bands comprises a first band, a second band and a third band and wherein the first band includes candidate cells with RSRP/RSRQ values higher than RSRP/RSRQ values of candidate cells in the second band and the third band, the second band includes candidate cells with RSRP/RSRQ values lower than RSRP/RSRQ values of candidate cells in the first band and higher than RSRP/RSRQ values of candidate cells in the third band, the third band includes candidate cells with RSRP/RSRQ values lower than RSRP/RSRQ values of candidate cells in the first band and second band,
wherein the at least three RSRP/RSRQ threshold values comprises a first RSRP/RSRQ threshold, a second RSRP/RSRQ threshold and a third RSRP/RSRQ threshold, and
arranging the three bands on three different levels, in descending order, of RSRP/RSRQ threshold values.

17. The apparatus as claimed in claim 14, wherein the nested dual level threshold-based sorting process further comprising:
filtering the plurality of neighbor cells in three bands based on the at least three RSRP/RSRQ threshold values, wherein the three bands comprises a first band, a second band and a third band and wherein the first band includes candidate cells with RSRP/RSRQ values higher than RSRP/RSRQ values of candidate cells in the second band and the third band, the second band includes candidate cells with RSRP/RSRQ values lower than RSRP/RSRQ values of candidate cells in the first band and higher than RSRP/RSRQ values of candidate cells in the third band, the third band includes candidate cells with RSRP/RSRQ values lower than RSRP/RSRQ values of candidate cells in the first band and second band;
wherein the at least three RSRP/RSRQ threshold values comprises a first RSRP/RSRQ threshold, a second RSRP/RSRQ threshold and a third RSRP/RSRQ threshold;
arranging the three bands on three different levels, in descending order, of RSRP/RSRQ threshold values; and
sorting the plurality of neighbor cells within the three bands in descending order of RSRP/RSRQ values, wherein a first neighbor cell in each of the three band has highest RSRP/RSRQ value compare to other neighbor cells in each of the three bands.

18. The apparatus as claimed in claim 14, wherein the nested dual level threshold-based sorting process further comprising:
filtering the plurality of neighbor cells in three bands based on the at least three RSRP/RSRQ threshold values, wherein the three bands comprises a first band, a second band and a third band and wherein the first band includes candidate cells with RSRP/RSRQ values higher than RSRP/RSRQ values of candidate cells in the second band and the third band, the second band includes candidate cells with RSRP/RSRQ values lower than RSRP/RSRQ values of candidate cells in the first band and higher than RSRP/RSRQ values of candidate cells in the third band, the third band includes candidate cells with RSRP/RSRQ values lower than RSRP/RSRQ values of candidate cells in the first band and second band,
wherein the at least three RSRP/RSRQ threshold values comprises a first RSRP/RSRQ threshold, a second RSRP/RSRQ threshold and a third RSRP/RSRQ threshold;
arranging the three bands on three different levels, in descending order, of RSRP/RSRQ threshold values;
sorting the plurality of neighbor cells within the three bands in descending order of RSRP/RSRQ values, wherein a first neighbor cell in each of the three band has highest RSRP/RSRQ value compare to other neighbor cells in each of the three bands;
filtering the sorted plurality of neighbour cell within the first band, from top, if the load value (PRB utilization) of the neighbour cell is less than at least one PRB threshold value; and
selecting the filtered neighbour cell as the target cell for handover.

19. The apparatus as claimed in claim 14, wherein the nested dual level threshold-based sorting process further comprising:
filtering the plurality of neighbor cells in three bands based on the at least three RSRP/RSRQ threshold values, wherein the three bands comprises a first band, a second band and a third band and wherein the first band includes candidate cells with RSRP/RSRQ values higher than RSRP/RSRQ values of candidate cells in the second band and the third band, the second band includes candidate cells with RSRP/RSRQ values lower than RSRP/RSRQ values of candidate cells in the first band and higher than RSRP/RSRQ values of candidate cells in the third band, the third band includes candidate cells with RSRP/RSRQ values lower than RSRP/RSRQ values of candidate cells in the first band and second band,
wherein the at least three RSRP/RSRQ threshold values comprises a first RSRP/RSRQ threshold, a second RSRP/RSRQ threshold and a third RSRP/RSRQ threshold;
arranging the three bands on three different levels, in descending order, of RSRP/RSRQ threshold values;
sorting the plurality of neighbor cells within the three bands in descending order of RSRP/RSRQ values, wherein a first neighbor cell in each of the three band has highest RSRP/RSRQ value compare to other neighbor cells in each of the three bands;
filtering the sorted plurality of neighbour cell within the first band, from top, if the load value (PRB utilization) of the neighbour cell is less than a first PRB threshold value;
selecting the filtered neighbour cell as the target cell for handover, if the load value (PRB utilization) of the neighbour cell is less than the first PRB threshold value;
filtering the sorted plurality of neighbor cell within the first band, from the top, if the load value (PRB utilization) of the neighbour cell is higher than the first PRB threshold value and lower than a second threshold value; and
selecting the filtered neighbour cell as the target cell for handover, if the load value (PRB utilization) of the neighbour cell is higher than the first PRB threshold value and lower than the second threshold value;

20. The apparatus as claimed in claim 14, wherein the nested dual level threshold-based sorting process further comprising:
filtering the plurality of neighbor cells in three bands based on the at least three RSRP/RSRQ threshold values, wherein the three bands comprises a first band, a second band and a third band and wherein the first band includes candidate cells with RSRP/RSRQ values higher than RSRP/RSRQ values of candidate cells in the second band and the third band, the second band includes candidate cells with RSRP/RSRQ values lower than RSRP/RSRQ values of candidate cells in the first band and higher than RSRP/RSRQ values of candidate cells in the third band, the third band includes candidate cells with RSRP/RSRQ values lower than RSRP/RSRQ values of candidate cells in the first band and second band,
wherein the at least three RSRP/RSRQ threshold values comprises a first RSRP/RSRQ threshold, a second RSRP/RSRQ threshold and a third RSRP/RSRQ threshold;
arranging the three bands on three different levels, in descending order, of RSRP/RSRQ threshold values;
sorting the plurality of neighbor cells within the three bands in descending order of RSRP/RSRQ values, wherein a first neighbor cell in each of the three band has highest RSRP/RSRQ value compare to other neighbor cells in each of the three bands;
filtering the sorted plurality of neighbour cell within the first band, from top, if the load value (PRB utilization) of the neighbour cell within the first band is less than at least one PRB threshold values;
selecting the filtered neighbour cell as the target cell for handover, if the load value (PRB utilization) of the neighbour cell within the first band is less than the at least one PRB threshold values;
filtering the sorted plurality of neighbor cell within the second band, from the top, if the load value (PRB utilization) of the neighbour cell within the first band is higher than or equal to the at least one PRB threshold values and if the load value (PRB utilization) of the neighbour cell within the second band is less than the at least one PRB threshold values; and
selecting the filtered neighbour cell within the second band as the target cell for handover, if the load value (PRB utilization) of the neighbour cell within the first band is higher than or equal to the at least one PRB threshold values and if the load value (PRB utilization) of the neighbour cell within the second band is less than the at least one PRB threshold values;
filtering the sorted plurality of neighbor cell within the third band, from the top, if the load value (PRB utilization) of the neighbour cell within the first band and second band is higher than or equal to the at least one PRB threshold values and if the load value (PRB utilization) of the neighbour cell within the third band is less than the at least one PRB threshold values; and
selecting the filtered neighbour cell within the third band as the target cell for handover, if the load value (PRB utilization) of the neighbour cell within the first band and the second band is higher than or equal to the at least one PRB threshold values and if the load value (PRB utilization) of the neighbour cell within the third band is less than the at least one PRB threshold values.

21. The apparatus as claimed in claim 14, wherein the nested dual level threshold-based sorting process further comprising:
filtering the plurality of neighbor cells in three bands based on the at least three RSRP/RSRQ threshold values, wherein the three bands comprises a first band, a second band and a third band and wherein the first band includes candidate cells with RSRP/RSRQ values higher than RSRP/RSRQ values of candidate cells in the second band and the third band, the second band includes candidate cells with RSRP/RSRQ values lower than RSRP/RSRQ values of candidate cells in the first band and higher than RSRP/RSRQ values of candidate cells in the third band, the third band includes candidate cells with RSRP/RSRQ values lower than RSRP/RSRQ values of candidate cells in the first band and second band,
wherein the at least three RSRP/RSRQ threshold values comprises a first RSRP/RSRQ threshold, a second RSRP/RSRQ threshold and a third RSRP/RSRQ threshold;
arranging the three bands on three different levels, in descending order, of RSRP/RSRQ threshold values;
sorting the plurality of neighbor cells within the three bands in descending order of RSRP/RSRQ values, wherein a first neighbor cell in each of the three band has highest RSRP/RSRQ value compare to other neighbor cells in each of the three bands;
filtering the sorted plurality of neighbour cell within the first band, from top, if the load value (PRB utilization) of the neighbour cell within the first band is less than at least one PRB threshold values;
selecting the filtered neighbour cell as the target cell for handover, if the load value (PRB utilization) of the neighbour cell within the first band is less than the at least one PRB threshold values;
filtering the sorted plurality of neighbor cell within the second band, from the top, if the load value (PRB utilization) of the neighbour cell within the first band is higher than or equal to the at least one PRB threshold values and if the load value (PRB utilization) of the neighbour cell within the second band is less than the at least one PRB threshold values; and
selecting the filtered neighbour cell within the second band as the target cell for handover, if the load value (PRB utilization) of the neighbour cell within the first band is higher than or equal to the at least one PRB threshold values and if the load value (PRB utilization) of the neighbour cell within the second band is less than the at least one PRB threshold values;
filtering the sorted plurality of neighbor cell within the third band, from the top, if the load value (PRB utilization) of the neighbour cell within the first band and second band is higher than or equal to the at least one PRB threshold values and if the load value (PRB utilization) of the neighbour cell within the third band is less than the at least one PRB threshold values; and
selecting the filtered neighbour cell within the third band as the target cell for handover, if the load value (PRB utilization) of the neighbour cell within the first band and the second band is higher than or equal to the at least one PRB threshold values and if the load value (PRB utilization) of the neighbour cell within the third band is less than the at least one PRB threshold values,
selecting the filtered neighbor cell from the top within the first band as the target cell for handover, if the load value (PRB utilization) of the neighbour cell within each of the three bands is higher than or equal to the at least one PRB threshold values,
wherein the selected neighbor cell from the top has the highest RSRP/RSRQ values in the sorted plurality of candidate cells.

22. The apparatus as claimed in claim 14, wherein the load value includes at least one of: average load value, mean load value, absolute load value and a range of load values.

23. The apparatus as claimed in claim 14, wherein the HO management unit (210) is further configured to:
create a data table of the plurality of candidate cells,
wherein the data table stores the received signal strength value (RSRP/RSRQ) and the load value (PRB utilization) for each candidate cells.

24. The apparatus as claimed in claim 14, wherein the nested dual level threshold-based sorting process is implemented by comparing the RSRP/RSRP values with at least three RSRP/RSRQ threshold values and by comparing the PRB utilization values with at least one PRB threshold values.

25. The apparatus as claimed in claim 14, wherein the apparatus provides a low power computation technique for sorting of the candidate cells.

26. The apparatus as claimed in claim 14, wherein the apparatus is implemented by a radio access network (RAN) intelligent controller in an Open-RAN environment.
